(19) United States
(12) Patent Application Publication
(10) Pub. No.: US 2025/0376339 A1
(43) Pub. Date: Dec. 11, 2025

(54) EQUIPMENT FOR HANDLING SHEET MATERIALS

(71) Applicant: BEDNAR ROBOTICS S.R.O., Pisek, Budejovicke Predmesti (CZ)

(72) Inventor: David BEDNAR, Pisek, Budejovicke Predmesti (CZ)

(73) Assignee: BEDNAR ROBOTICS S.R.O., Pisek, Budejovicke Predmesti (CZ)

(21) Appl. No.: 19/230,599

(22) Filed: Jun. 6, 2025

(30) Foreign Application Priority Data
Jun. 7, 2024 (CZ) PV2024-237

(51) Int. Cl. B65G 47/91; B25J 15/06; B65G 47/90; B65G 49/06

(52) U.S. Cl. CPC B65G 47/915; B65G 47/904; B25J 15/0616; B65G 49/067

(57) ABSTRACT

A sheet material handling equipment includes a handling fixture having a frame adapted for attachment to a robot or manipulator; at least two arms anchored to the frame, each arm being formed by at least two semi-arms pivotally connected to each other and including a gripping member at its free end, the pivotal connection including a rotatable joint with a joint coupling having a joint brake, which are passive with a pressure or electric lock; and a first control line for distributing electrical power, and/or air, and/or hydraulic fluid for controlling the joint and/or the gripping member connected via an adapter to (a) an electrical power supply, and/or hydraulic fluid, and/or air to the robot or manipulator and to (b) a work line control unit, and an adjusting fixture structured to actively adjust a position of at least one of the arms and/or to unlock the joint brake.

### CROSS-REFERENCE TO RELATED APPLICATIONS

This application claims priority to Czech application No. PV 2024-237 filed Jun. 7, 2024, the disclosure of which is hereby incorporated in its entirety by reference herein.

### TECHNICAL FIELD

The present disclosure relates to a device for handling sheet materials, the device being intended primarily for automated plants with robotic devices for transferring and moving sheet material blanks, mainly sheet metal, for further processing.

### BACKGROUND

In the electrical industry, in the automotive industry, in mechanical engineering, in the metallurgical industry, but also in many other operations such as warehouses and large warehouses, it is necessary to handle metallurgical materials of larger dimensions. These metallurgical materials, objects, are moved from point A to point B. However, these materials may be dangerous, bulky, or too heavy for conventional manual handling. The classical and commonly used method of transport are manipulators and pallet trucks, which allow the transport of large sheets of metal outdoors and indoors. The disadvantage of this solution is that this method is suitable for transport mainly in warehouses, during loading and reloading, etc., where larger volumes of material are transported. It is not suitable for transporting single sheets of metal sheets and, moreover, for filling production lines.

These shortcomings are typically eliminated by the carrier frames equipped with a holding mechanism designed to hold the carried sheet object firmly so that it does not come loose during transportation. In the case of metallic iron or steel sheets, it is advisable to take advantage of the physical properties of the iron and to use magnetic clips for a firm grip. The magnetic clips use electromagnets which, when electricity passes through their coil, magnetize their core which then firmly anchors the steel plate, and as long as the flow of electricity is not interrupted, the magnetism continues.

Magnetic applications can be divided into two main groups: belt magnets and magnetic clamps. Belt magnets are used to clamp and release metallic materials without damaging the load. Magnetic clamps, on the other hand, can instantly fix an object without deformation, making it accessible from five sides during grinding, milling, circular machining, etc. Both of these types are further divided according to the technology used into permanent magnets, electro permanent magnets, electromagnets, and battery magnets. Walmag is an example of the use of these technologies. The disadvantage of these technologies, since electromagnets are the most commonly used, is that magnet-based handling devices are very heavy and need a sturdy frame to carry them. In the event of an accidental interruption of electrical power, the sheet metal being moved is not protected by anything.

An analogue of magnetic technology is the technology using vacuum, i.e. air void, and vacuum grippers. The gripper, when attached to the sheet metal, creates an insulated cavity between the sheet metal and the gripper, from which air is sucked out and the resulting vacuum creates a clamping force holding the sheet metal to the gripper. Again, this technology is dependent on a vacuum of air generated by a compressor or rather an electrically driven vacuum pump, so an electric current is also required. However, the advantage is that once the vacuum is created, it is protected by a vacuum valve that will not open unless it receives an electrical impulse, i.e. the connection between the gripper and the sheet metal will not release in the event of a power failure. In addition, non-magnetic materials such as plastics, glass, etc. can also be moved by vacuum.

An essential part of this transport technology is the transport frame, which is attached to a supporting element, e.g. a manipulator, crane, robotic arm, etc. The carrying frame then has grippers with vacuum grippers.

From previous practice, a handling frame with tentacles is known, where the tentacles are arranged on the frame in a fixed geometry. An actuator or gripper with a vacuum head is located at the end of the gripper, and some technologies are already known where each vacuum head has its own air shut-off. These frames are used to grip the same shape and size of the sheet material being transferred. The frame also includes pressure lines in the form of hoses and electrical lines for controlling vacuum valves, position and vacuum sensors. The advantages of this technology are low weight, simplicity of the system, and relatively low cost. The disadvantage of this design is the non-universality, because for each shape of sheet material it is necessary to make an exchange and to have in stock the entire handling equipment, handling equipment. Due to the necessity of exchange, operational downtime etc. occurs.

The shortcomings of this device are overcome by the technology where the handling frame is equipped with arms with variable arm geometry. Each arm is usually equipped with at least one joint which is driven by a separate electric motor. The electric motor is controlled remotely, but part of each arm is an electric drive control unit. The electric drive allows the shape of the arm to be adjusted to the desired position, according to the shape and size of the board being gripped. An example of this technology is document U.S. Pat. No. 11,059,168 B2. Here, each arm has a pair of joints that are capable of independent movement of each other, and the arm is also provided with a clutch that turns on and off the ability to move both joints. The advantage is a fully functional active change of the geometry of the arms according to the customer's requirement, i.e. when changing the type or size of the material to be transferred, it is quite easy and quick to make a complete adjustment of the geometry of the handling frame without much production downtime. The main disadvantage is the complexity of this technology, where electric motors are part of each gripper. A high number of electric motors means high weight and the risk of increased failure of the whole device. If one electric motor fails, the whole device becomes inoperative. In addition, the high weight of components and wiring must be compensated for by stronger and more expensive materials or by the larger size and robustness, and thus load capacity, of the handling frame. Typically, the operation of the individual components of the handling frame and the carrier of the frame is controlled and managed by a programmable logic controller (PLC). This is basically an industrial computer that is very robust and is adapted to control production processes, i.e. the work of assembly lines, machines, robotic equipment, etc. PLC is suitable where high reliability of control and operation, easy programming, and simultaneous diagnosis of possible errors are required.

There is a need for a new solution which would overcome the shortcomings of the solutions known from the current state of the art, to design and build such a device for handling sheet materials, which would have all the advantages of the device according to the document U.S. Pat. No. 11,059,168 B2, but at the same time would be lighter, would have higher reliability, i.e. would contain fewer electrical components, wiring.

### SUMMARY

In one or more embodiments, a sheet material handling equipment is disclosed. The equipment includes a handling fixture including a support frame with at least one adapter or fixture adapted for attaching the support frame to a robot or a manipulator; at least two arms fixedly or pivotally anchored to the support frame, each arm being formed by at least two semi-arms pivotally connected to each other, at least one semi-arm of the at least two semi-arms including at least one gripping member at its free end, the pivotal connection between the at least two semi-arms, and/or the at least two arms, and the support frame includes a rotatable joint with a joint coupling provided with a joint brake, the joint coupling with the joint brake being passive with a pressure or an electric lock; and a first control line for distributing electrical power, and/or air, and/or hydraulic fluid for controlling the joint and/or the at least one gripping member connected via an adapter to (a) an electrical power supply, and/or hydraulic fluid, and/or air to the robot or the manipulator and to (b) a work line control unit provided with a first software module carrying instructions for controlling a flow of air, and/or electrical energy, and/or hydraulic fluid to the joint and/or the at least one gripping member, and at least one adjusting fixture structured to actively adjust a position of at least one of the at least two arms and/or to unlock the joint brake.

### BRIEF DESCRIPTION OF THE DRAWINGS

The disclosure will be explained in more detail using the drawings which illustrate the following:

FIG. 1 is a 3D perspective view of the sheet material handling equipment in the state of placing a handling fixture on an adjusting fixture, according to one or more embodiments disclose herein; control wiring, control elements, and operating elements are not shown;

FIG. 2 is a 3D perspective view of the sheet material handling equipment in the state of separating the handling fixture from the adjusting fixture; control wiring, control elements, and operating elements are not shown;

FIG. 3 is a 3D perspective view of a stand-alone handling fixture in a 16-arm design, including one fixed semi-arm and one swivel semi-arm with vacuum suction cups on the swivel semi-arm; control wiring, control elements, and operating elements are not shown;

FIG. 4 is a 3D perspective view of a stand-alone adjusting fixture with two longitudinal linear rails, two transverse linear rails, and two adjusting devices; the drives are electric, with the longitudinal and transverse motion lines including a linear belt rail;

FIG. 5 is a side view of the sheet material handling device in the state of separating the handling fixture from the adjusting fixture; control wiring, control elements, and operating elements are not shown; and

FIG. 6 is a side detailed view of the adjusting device connected to the arm.

### DETAILED DESCRIPTION

The disclosure described herein overcomes the shortcomings of currently known devices for handling sheet materials. The sheet material handling device disclosed herein comprises two basic parts, which are a handling fixture and an adjusting fixture. The essence of this solution is the elimination of complexity of a traditional handling device. The handling device, disclosed herein, is divided into a part that physically handles the sheets and other sheet materials, and an adjusting part that is located in one of the adjacent sections of the work line. The part that performs the direct handling motion is the handling fixture, which is based on passive elements, thus being free of electric drives or other types of joint drives, while also significantly reduces the amount of control wiring required to operate the various moving elements that use electricity, pressurized air, or hydraulic fluid to move. Also, the control wiring is freed from separate control units for individual drives.

The base of the handling fixture is a support frame that is fitted with at least one adapter or fixture. The at least one adapter or fixture serves to attach the support frame to a robot or a manipulator, which moves the support frame as a compact unit within the handling space of the work line. At least two arms are fixedly or pivotally attached to the support frame, each arm being divided into at least two semi-arms. At least one of the semi-arms is pivotally attached to the other. Typically, the semi-arm connected to the support frame is fixedly attached to that support frame. At least one pivotally attached semi-arm is provided with at least one gripping member or gripper; it is always a semi-arm located furthest from the support frame. At least one joint is arranged between the movably coupled semi-arms. The at least one joint includes a joint coupling provided with a joint brake. The handling device is further provided with a first control line for distributing electrical power, and/or air, and/or hydraulic fluid. The first control line is used to control the joint and/or the gripping member or gripper. The first control line is connected via an adapter to the electrical power, and/or air, and/or hydraulic fluid distribution of the robot or the manipulator. The electrical wiring and the air and hydraulic wiring controls are then connected to a work line control unit, which is provided with a first software module that carries instructions for controlling the flow of air, and/or electrical energy, and/or hydraulic fluid to the joint and/or gripper. The joint is rotatable, the joint coupling with the joint brake being passive with a pressure or electric lock. The sheet material handling equipment further includes at least one adjusting fixture for actively adjusting the position of the arm and/or for unlocking the joint brake.

In a preferred embodiment, the adjusting fixture includes an adjusting frame having at least two parallel longitudinally disposed longitudinal members and at least two parallel transversely disposed cross members joined together to form a compact unit. The adjusting frame is provided with at least one longitudinal linear rail and at least one transverse linear rail. Further, the adjusting frame is also provided with at least one adjusting device for actively adjusting the position of the arm and/or for unlocking the joint brake. The adjusting device is arranged on the transverse linear rail. The adjusting frame is further provided with at least two support arms for mounting the handling fixture on the adjusting fixture, and also with a second control line adapted to be connected to the power and/or hydraulic fluid and/or air supply of the working line. This work line distribution is connected to a work line control unit, the control unit being provided with a second software module carrying instructions for controlling the flow of electrical power, and/or hydraulic fluid, and/or air to a transverse drive unit, a longitudinal drive unit, and an adjusting device.

In another preferred embodiment, the longitudinal linear rail includes at least one longitudinal drive unit, at least one motion stop, at least one longitudinal motion line, and a sliding beam. The longitudinal drive unit is arranged at one end of the adjusting frame. The sliding beam is mounted on longitudinal rails which are mounted on at least two parallel longitudinal members.

In a further preferred embodiment, the transverse linear rail includes at least one transverse drive unit arranged at one end of the sliding beam. The sliding beam is provided with a transverse motion line on which the adjusting device is mounted.

In the following preferred embodiment, the longitudinal drive unit and the transverse drive unit are linear stepper motors or servo motors. The longitudinal motion line and the transverse motion line are any of the devices of the group including: a linear belt rail, a magnetic linear rail, a motion screw rail, a toothed rack rail. The longitudinal motion line and the transverse motion line allow movement of the adjusting device in two horizontal axes, the longitudinal motion line moving the transverse motion line in one longitudinal axis and the transverse motion line moving the adjusting device itself in the transverse axis. However, the motion effect would be the same if the longitudinal motion line moved the adjusting device and the transverse motion line moved it.

In yet another advantageous embodiment, the adjusting device includes a carrier with an adjusting drive fitted with an adjusting arm. The adjusting arm is pivotally arranged on the shaft of the adjusting drive and is provided with a vertical extension drive with a gripping fork. The vertical extension drive is a linear drive of pneumatic, electric, or electromagnetic origin. The vertical extension drive is then used to move the gripping fork vertically, which in its upper part grips and secures the gripped semi-arm and, after the joint is unblocked, i.e. by releasing the joint brake via a supply of external energy or pressure fluid, allows the adjusting arm to rotatably set a new horizontal position of the functional member.

In another advantageous embodiment, the control unit is a part of a single programmable logic controller PLC that controls the operation of the entire work line, which is also equipped with a third software module. The third software module carries information for controlling the movement of the robot or manipulator. The PLC is further provided with a Human Machine Interface driver, designed to program, monitor, control, and collect data from the programmable logic controller.

In a further advantageous embodiment, the adjusting drive is an electric motor.

In a further advantageous embodiment, the adapter is provided with an electrical switchboard cabinet for connecting the first control line, in an electrical embodiment, with the power distribution of the robot or the manipulator and the work line control unit. The function of the switchboard cabinet can be replaced, for example, by a connector connection of the two electrical wirings.

In yet another advantageous embodiment, the adapter is provided with a valve terminal for connecting the first control line, in the pressure embodiment, to a pressure line of the robot or the manipulator. As mentioned above, the pressure manifold may be air or hydraulic.

In another advantageous version, the electrical switchboard cabinet is equipped directly with the electric drives.

The main advantage of the present disclosure is that the configuration of the sheet material handling device is technically simpler, cheaper, and much lighter than conventional devices used in the market. As a result, a less powerful and therefore less expensive crane, robotic arm, or other device carrying and handling sheet material handling equipment can be used to carry the sheet material handling equipment. Fewer control and motion electronics, electrical, pneumatic, and hydraulic circuits located directly on the sheet material handling equipment make the equipment lighter, but also more reliable, and less likely to fail. The lighter design is also due to the division of the traditional sheet material handling equipment into a handling fixture and adjusting fixture, where passive elements can be used to control the joints.

### EXAMPLES

### Example 1

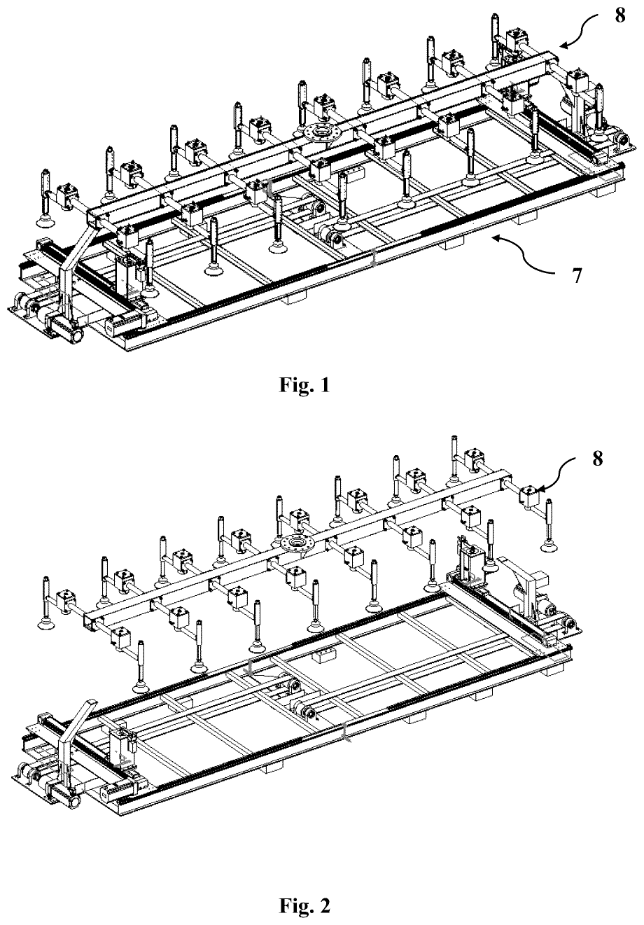

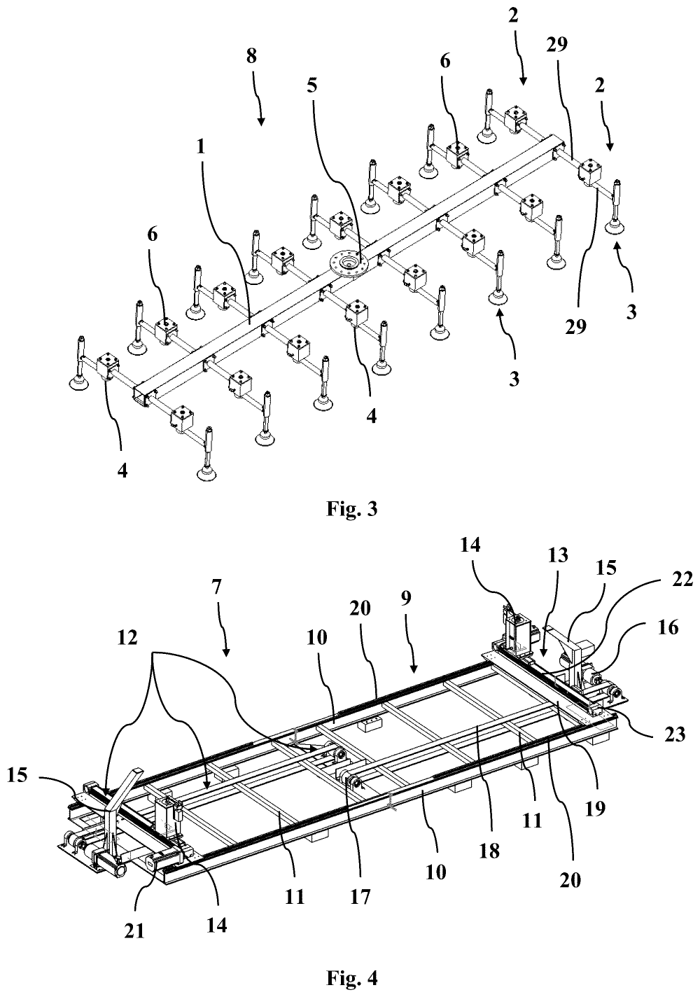

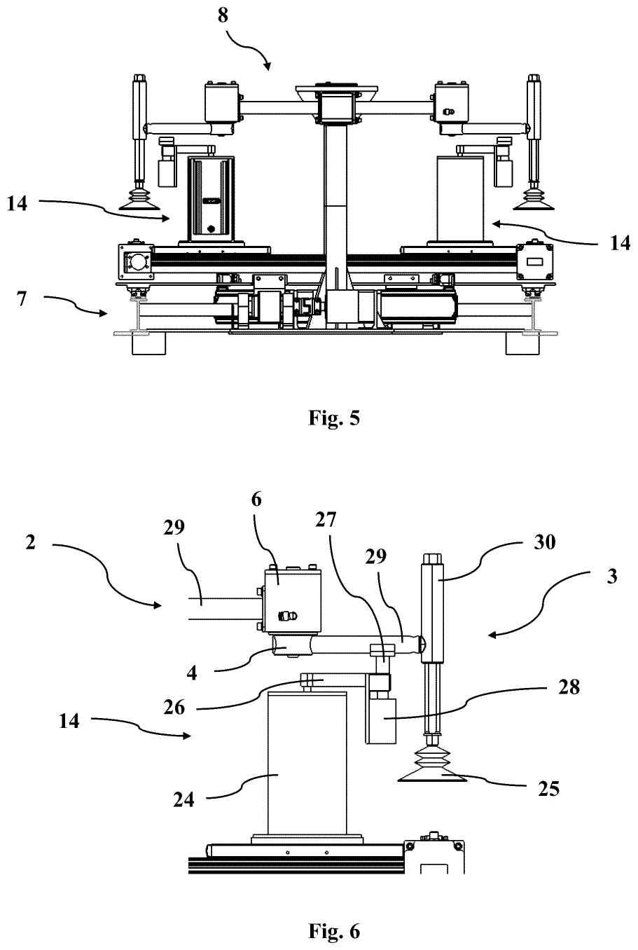

The sheet material handling device, as shown in FIGS. 1-6, includes a handling fixture 8, the base of which is a support frame 1. The frame 8, in this non-limiting example, includes a single adapter 5 by which the support frame 1 is fixed to a robot or the manipulator. The support frame 1 is further provided with arms 2 formed by a pair of semi-arms 29. The semi-arms 29 arranged closer to the support frame 1 are fixedly attached to the support frame 1. The second semi-arm 29 of the arm 2 is then pivotally fixed to the fixedly anchored semi-arm 29. The pivotal connection of the two semi-arms 29 is formed by a joint 4 with a joint coupling 6, which is provided with a joint brake. The movably fixed semi-arm 29 is provided at its free end with a single gripping member 3.

The handling fixture 8 is provided with a first control line (not shown) which enables distribution of electrical power, and/or air, and/or hydraulic fluid over the handling fixture 8 to facilitate control of movement functions. A non-displayed first control conduit for electrical power, and/or air, and/or hydraulic fluid is by default connected to the electrical power, and/or air, and/or hydraulic fluid conduit of the robot or the manipulator and through it to a non-displayed work line control unit provided with a first software module. The first software module carries instructions for controlling the flow of air, and/or electrical energy, and/or hydraulic fluid to the joint 4. In this non-limiting example, the joint 4 is rotatable, and the joint coupling 6 with the joint brake is passive with an electric lock.

The sheet material handling equipment further includes an adjusting fixture 7, as illustrated in FIGS. 1, 2, 4, and 5. The base of the adjusting fixture 7 is an adjusting frame 9. The adjusting frame 9 is formed by two parallel longitudinal members 10 and eight parallel cross members 11, which are joined together to form a compact unit. The adjusting frame 9 is further provided with two longitudinal linear rails 12 and two transverse linear rails 13. Each transverse linear rail 13 is provided with a single adjusting device 14. The adjusting frame 9 is further provided with two supporting arms 15 for mounting the handling fixture 8 on the adjusting fixture 7. Also, the adjusting frame 9 is provided with an electrical line (not shown) connected to the electrical line of the work line and its control unit. The control unit is also provided with a second software module for this purpose, which carries instructions for controlling a flow of electrical power simultaneously to the transverse drive unit 21, the longitudinal drive unit 16, and the adjusting device 14.

According to the same non-limiting example, each longitudinal linear rail 12 includes one longitudinal drive unit 16 arranged at one end of the adjusting frame 9. Each longitudinal linear rail 12 also includes two motion stops 17 of the longitudinal motion line 18. The sliding beam 19 is mounted on two longitudinal rails 20 for longitudinal movement, which are mounted on the longitudinal members 10. Each transverse linear rail 13 includes one transverse drive unit 21, which is arranged at one end of the sliding beam 19. The sliding beam 19 is provided with a transverse motion line 22 on which the adjusting device 14 is mounted. The longitudinal drive unit 16 and the transverse drive unit 21 are linear stepper motors, and the longitudinal motion line 18 and the transverse motion line 22 are linear belt drives. Each adjusting device 14, as shown in the non-limiting example of FIG. 6, includes a carrier 24 with an adjusting drive, which is a vertically mounted electric motor. An adjusting arm 26 is mounted to the electric motor's motion shaft. The adjusting arm 26 is provided with a linear electric vertical extension drive 28, which is a servo motor. The vertical extension drive 28 is fitted with a gripping fork 27.

### Example 2

In this non-limiting example formed according to Example 1, the difference is that the adapter 5 is provided with a valve terminal. The first pressure control line is connected to the valve terminal and through the valve terminal to the pressure control line of the robot or the manipulator.

The invention will find application in industrial plants where large flat plates, such as large sheets of metal, are handled.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

### REFERENCE DESIGNATIONS

1 support frame
2 arm
3 gripping member
4 joint
5 adapter
6 joint coupling
7 adjusting fixture
8 handling fixture
9 adjusting frame
10 longitudinal member
11 cross member
12 longitudinal linear rail
13 transverse linear rail
14 adjusting device
15 supporting arm
16 longitudinal drive unit
17 motion stop
18 longitudinal motion line
19 sliding beam
20 longitudinal rail
21 transverse drive unit
22 transverse motion line
23 transverse stop
24 carrier
25 vacuum suction cup
26 adjusting arm
27 gripping fork
28 vertical extension drive
29 semi-arm
30 functional member

What is claimed is:

1. A sheet material handling equipment comprising:
a handling fixture including
a support frame with at least one adapter or fixture adapted for attaching the support frame to a robot or a manipulator;
at least two arms fixedly or pivotally anchored to the support frame, each arm being formed by at least two semi-arms pivotally connected to each other, at least one semi-arm of the at least two semi-arms including at least one gripping member at its free end, the pivotal connection between the at least two semi-arms, and/or the at least two arms, and the support frame includes a rotatable joint with a joint coupling provided with a joint brake, the joint coupling with the joint brake being passive with a pressure or an electric lock; and
a first control line for distributing electrical power, and/or air, and/or hydraulic fluid for controlling the joint and/or the at least one gripping member connected via an adapter to (a) an electrical power supply, and/or hydraulic fluid, and/or air to the robot or the manipulator and to (b) a work line control unit provided with a first software module carrying instructions for controlling a flow of air, and/or electrical energy, and/or hydraulic fluid to the joint and/or the at least one gripping member; and
at least one adjusting fixture structured to actively adjust a position of at least one of the at least two arms and/or to unlock the joint brake.

2. The equipment of claim 1, wherein the at least one adjusting fixture includes an adjusting frame comprising:
at least two parallel longitudinal members and at least two parallel cross members connected into one compact unit;
at least one longitudinal linear rail;
at least one transverse linear rail;
at least one adjusting device structured to actively adjust the position of at least one of the at least two arms and/or to unlock the joint brake, the adjusting device being arranged on the at least one transverse linear rail;
at least two supporting arms arranged to mount the handling fixture onto the at least one adjusting fixture; and
a second control line for distributing electrical power, and/or hydraulic fluid, and/or air connected to (a) the electrical power, and/or hydraulic fluid, and/or air distribution of the work line and to (b) the work line control unit provided with a second software module carrying instructions for controlling a flow of electrical power, and/or hydraulic fluid, and/or air to a transverse drive unit, at least one longitudinal drive unit, and the adjusting device.

3. The equipment of claim 2, wherein the at least one longitudinal linear rail comprises
the at least one longitudinal drive unit arranged at one end of the adjusting frame;
at least one longitudinal motion line with at least one motion stop; and
a sliding beam mounted on longitudinal rails which are attached to the at least two parallel longitudinal members.

4. The equipment of claim 2, where the at least one transverse linear rail comprises
at least one transverse drive unit arranged at one end of a sliding beam provided with a transverse motion line slidably housing the at least one adjusting device.

5. The equipment of claim 3, wherein the at least one longitudinal drive unit is a linear stepper motor or servo motor.

6. The equipment of claim 4, wherein the at least one transverse drive unit is a linear stepper motor or servo motor.

7. The equipment of claim 3, wherein the at least one longitudinal motion line is a linear belt rail, magnetic linear rail, motion screw rail, or toothed comb rail.

8. The equipment of claim 4, wherein the transverse motion line is a linear belt rail, magnetic linear rail, motion screw rail, or toothed comb rail.

9. The equipment of claim 2, wherein the adjusting device comprises a carrier with an adjusting drive fitted with an adjusting arm having a gripping fork fixed via a linear pneumatic, electric, or electromagnetic vertical extension drive to the adjusting arm.

10. The equipment of claim 9, wherein the adjusting arm is mounted on a shaft of the adjusting drive.

11. The equipment of claim 9, wherein the adjusting drive is an electric motor.

12. The equipment of claim 2, wherein the at least one adapter includes an electrical switchboard cabinet for connecting the first control line with an electrical circuit of the robot or the manipulator and the work line control unit.

13. The equipment of claim 12, wherein the electrical switchboard cabinet includes electric drives.

14. The equipment of claim 2, wherein the at least one adapter includes a valve terminal for connecting the first control line to a pressure line of the robot or the manipulator.

15. The equipment of claim 1, wherein the handling fixture and the at least one externally arranged adjusting fixture are physically separable from each other.

16. The equipment of claim 1, wherein the at least one adjusting fixture is externally arranged with respect to the handling fixture.

17. The equipment of claim 2, wherein the at least two parallel longitudinal members are longitudinally disposed and the at least two parallel cross members are transversely disposed within the adjusting frame.

18. The equipment of claim 1, wherein the handling fixture is free of electric drives.
